(19) United States
(12) Patent Application Publication
(10) Pub. No.: US 2021/0397454 A1
(43) Pub. Date: Dec. 23, 2021

(54) INSTRUCTION TO VECTORIZE LOOPS WITH BACKWARD CROSS-ITERATION DEPENDENCIES

(71) Applicant: Intel Corporation, Santa Clara, CA (US)

(72) Inventors: Mikhail Plotnikov, Nizhny Novgorod NIZ (RU); Hideki Ido, Sunnyvale, CA (US); Ilya Burylov, Nizhny Novogorod NGR (RU); Ruslan Arutyunyan, Nizhny Novogorod (RU)

(73) Assignee: Intel Corporation, Santa Clara, CA (US)

(21) Appl. No.: 16/905,914

(22) Filed: Jun. 18, 2020

(51) Int. Cl. G06F 9/38; G06F 9/22; G06F 9/30

(52) U.S. Cl. CPC G06F 9/3838; G06F 9/30065; G06F 9/30145; G06F 9/223

(57) ABSTRACT

Methods and apparatus relating to techniques for vectorizing loops with backward cross-iteration dependencies are described. In an embodiment, execution of one or more instructions resolves a cross-iteration dependency of one or more operations of a loop. The execution of the one or more instructions resolves the cross-iteration dependency of the one or more operations based at least in part on one or more distance count computations to a preceding iteration of the loop. Other embodiments are also disclosed and claimed.

### FIELD

The present disclosure generally relates to the field of electronics. More particularly, some embodiments relate to techniques to use an instruction to vectorize loops with backward cross-iteration dependencies.

### BACKGROUND

To improve performance, some computer systems may use a processor capable of vector processing, e.g., to process large amounts of data in parallel. For example, vector processing may be applied in single-instruction, multiple-data (SIMD) computing, where multiple streams of data are processed in accordance with a single instruction. Hence, computing speed and/or efficiency can benefit significantly by employing vector processing.

### BRIEF DESCRIPTION OF THE DRAWINGS

So that the manner in which the herein recited features of the present embodiments can be understood in detail, a more particular description of the embodiments may be had by reference to embodiments, some of which are illustrated in the appended drawings. It is to be noted, however, that the appended drawings illustrate only typical embodiments and are therefore not to be considered limiting of their scope.

FIG. 1 is a sample diagram with a sequence of 24 generated numbers, results of condition evaluation over each number, and resulting X and Y values distribution, according to an embodiment.

FIG. 2 is a sample diagram with mask (01110011) and sample generated distances, according to an embodiment.

FIG. 3 shows a comparison of software emulation sequence results with manually computed distances in the whole sequence, according to an embodiment.

FIG. 4 illustrates an example for the first two vector iterations from FIG. 1, according to an embodiment.

FIG. 5 shows two examples of vectorization, according to some embodiments.

FIG. 6 illustrates a flow chart of a method to vectorize loops with backward cross-iteration dependencies, according to an embodiment.

FIG. 7A is a block diagram illustrating an exemplary instruction format according to embodiments.

FIG. 7B is a block diagram illustrating the fields of the instruction format that make up the full opcode field according to one embodiment.

FIG. 7C is a block diagram illustrating the fields of the instruction format that make up the register index field according to one embodiment.

FIG. 7D is a block diagram illustrating the fields of the instruction format that make up the augmentation operation field according to one embodiment.

FIG. 8 is a block diagram of a register architecture according to one embodiment.

FIG. 9A is a block diagram illustrating both an exemplary in-order pipeline and an exemplary register renaming, out-of-order issue/execution pipeline according to embodiments.

FIG. 9B is a block diagram illustrating both an exemplary embodiment of an in-order architecture core and an exemplary register renaming, out-of-order issue/execution architecture core to be included in a processor according to embodiments.

FIG. 10 illustrates a block diagram of an SOC (System On Chip) package in accordance with an embodiment.

FIG. 11 is a block diagram of a processing system, according to an embodiment.

FIG. 12 is a block diagram of an embodiment of a processor having one or more processor cores, according to some embodiments.

FIG. 13 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As mentioned above, computing speed and/or efficiency can benefit significantly by employing vector processing by processing large amounts of data in parallel. Furthermore, loop operations are commonly used in computing to perform various (e.g., repetitive) tasks. Hence, it could be very beneficial to vectorize loop operations. However, all loop operations cannot be currently vectorized due to various issues, such as loop operations that include backward cross-iteration dependences.

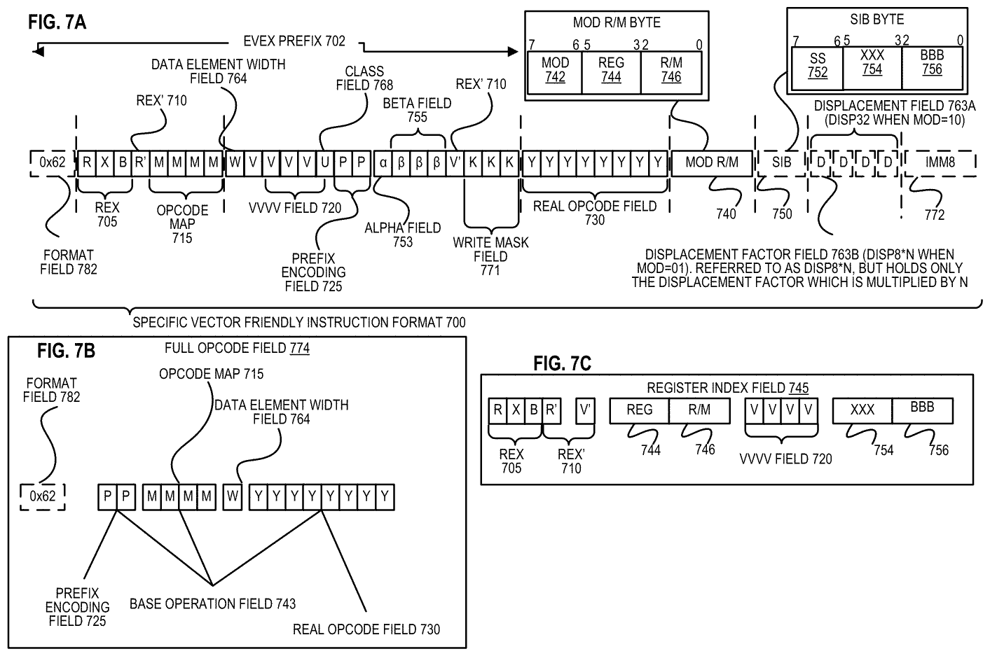

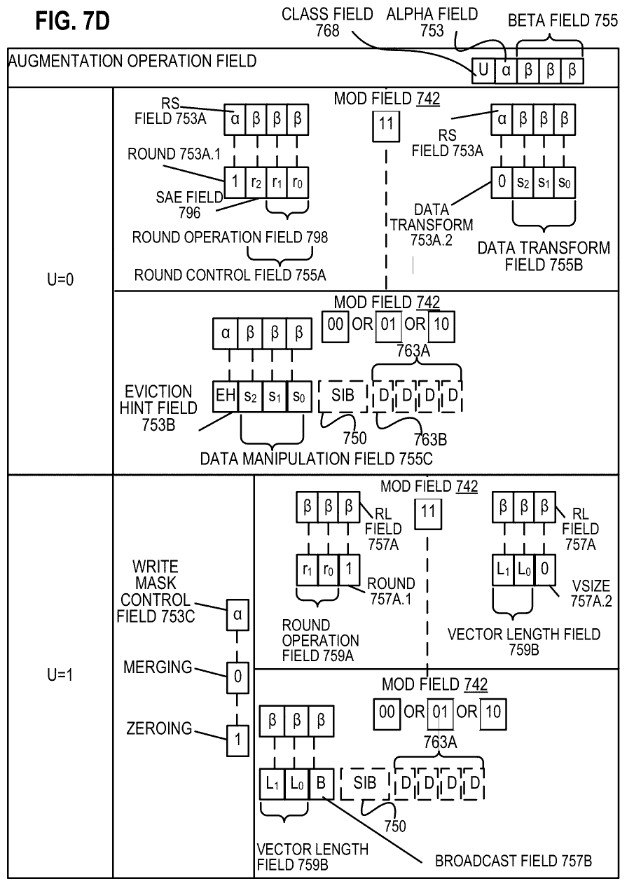

To this end, some embodiments provide techniques for vectorizing loops with backward cross-iteration dependencies. More particularly, one or more embodiments provide a single instruction to vectorize loops with backward cross-iteration dependencies. The single instruction may provide distance counting functionality by resolving cross-iteration dependences based on counting distance(s) to the preceding iteration(s) (where the dependencies terminate). In some embodiments, more than one instruction may be used to vectorize loops with backward cross-iteration dependencies. In at least one embodiment, the new instruction follows the EVEX format (such as discussed with reference to FIGS. 7A-7C.

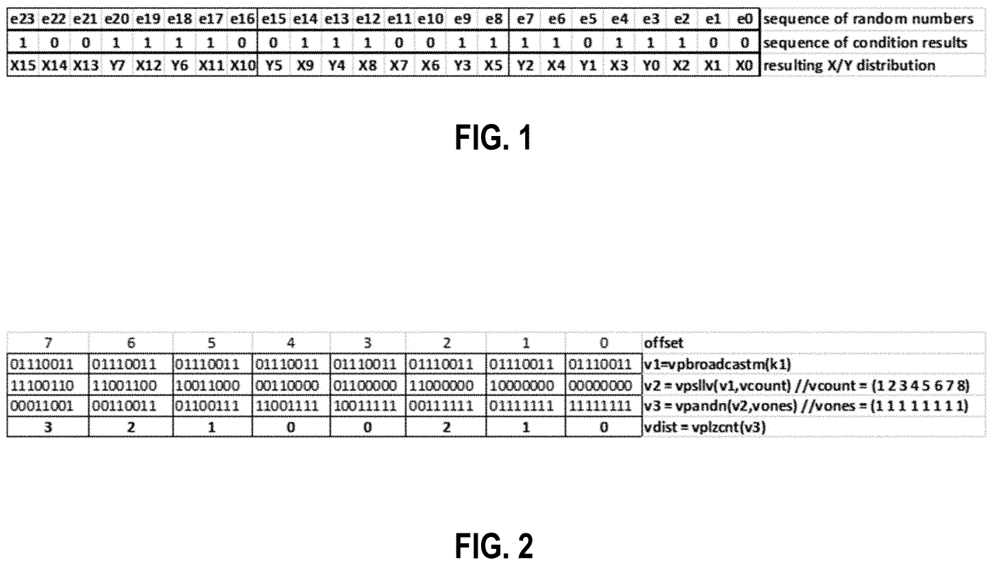

Further, some embodiments may be applied in computing systems that include one or more processors (e.g., where the one or more processors may include one or more processor cores), such as those discussed with reference to FIG. 1 et seq., including for example a desktop computer, a work station, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

As mentioned above, one embodiment solves vectorization problems of loops with backward cross-iteration dependencies. The dependencies may be resolved based at least in part on counting the distance to a preceding iteration, where a dependency breaks off or terminates.

For example, consider the following loop (referred to herein as “Example 1”):

for(i=0, k=0; i<N; i++) {

x[i] = k;
if(condition(i)) {

k++;

}else{

k = 0;

}

}

Another example below (referred to herein as “Example 2”) of such dependency is a loop which consumes an input sequence of values (e.g., sequence of pseudo/quasi random numbers) and conditionally divides the values into two bins:

for(i=0, k=0; i<N; i++) {

x[i] = generate_rng( );
if(condition( x[i] )) {

y[k++] = generate_rng( );

}

}

In Example 2, each call to RNG (which is a Random Number Generator function) provides a value from a sequence of pseudo-random numbers. The whole sequence can be generated by vector RNG API (Application Programming Interface), but it is unknown which number will end up in bin X, and which will end up in bin Y. This leads to complex data dependency between different iterations of the loop which prevents vectorization.

In at least one embodiment, the problem can be reduced to calculating distances to the nearest preceding zero in a sequence of condition evaluation results over generated random numbers. Because at the points where zero is met, cross-iteration dependency chain breaks. Hence, the Example 2 pattern can be reduced to Example 1 pattern and efficiently vectorized. FIG. 1 is a sample diagram with a sequence of 24 generated numbers, results of condition evaluation over each number and resulting X and Y values distribution, according to an embodiment.

Moreover, counting distance to the nearest zero functionality can be software (SW) emulated by the instruction sequence:

v1 = vpbroadcastm(k1);

| | |
|---|---|
| v2 = vpsllv(v1, vcount); | //vcount = (1, 2, 3, 4, ..., KL), order is from |
| | //right to the left |
| v3 = vpandn(v2, vones); | //vones = (1, 1, 1, 1, ..., 1) |

vdist = vplzcnt(v3);

Here, k1 is an input mask with results of condition evaluation over vector of random numbers generated; vcount and vones are pre-defined constants; vdist is a resulting vector with calculated distances to the nearest zero to the right in the input mask; v1-v3 are temporal vectors.

To understand how this sequence works, consider the example shown in FIG. 2, which takes mask (01110011) in order from the right to the left and generates distances. This instruction sequence natively supports only 8-bit and 16-bit masks due to limitations of the VPBROADCAS™ instruction. For example, a 64-bit mask will require 64 distances in the result, but intermediate v1 can at most hold eight 64-bit elements in a 512-bit (e.g., ZMM) register such as the registers discussed with reference to FIG. 7 et seq. This reduces vector efficiency to a quarter of possible maximum achieved with a 64-bit masks.

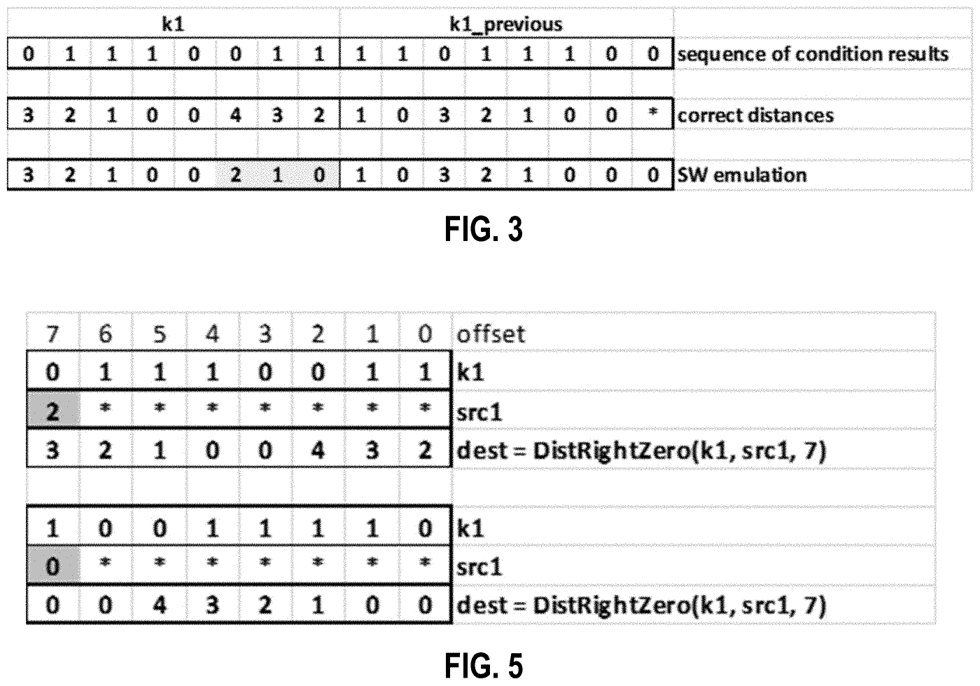

One more problem is that this sequence provides no visibility into distances in the previous masks. The issue is demonstrated in FIG. 3, which compares the results of this sequence with manually computed distances in the whole sequence. In FIG. 3, the incorrectly counted values are shaded (see the last row).

As can be seen in FIG. 3, a mismatch occurs because pre-history of distances has to be taken into account when an unset bit in the given mask is not met scanning backward from a certain position. Hence, this affects lower positions and including position of the first zero in the mask. To handle previous distances additional overhead is incurred. To this end, one embodiment aims to resolve problems of this pattern vectorization by one Instruction Set Architecture (ISA) extension or a single vector instruction.

An SIMD software solution for distance counting functionality (e.g., to achieve the vectorized Example 1 loop) can be implemented as follows:

| | |
|---|---|
| vdist_add = 0; | //initiate previous distance with zeroes |

for(i=0; i<N; i+=KL){
k1 = vector_condition(i, i+1, ..., i+KL−1);
v1 = vpbroadcastm(k1);
v2 = vpsllv(v1, vcount); //vcount = (1, 2, 3, 4, ..., KL), order is from right

//to left

v3 = vpandn(v2, vones); //vones = (1, 1, 1, 1, ..., 1)

| | |
|---|---|
| vdist = vplzcnt(v3); | //counted distances in current k1 mask as |
| | //if no pre-history |
| gpr1 = kmov(k1); | //start sequence to detect elements in k1 |
| | //which require update |
| gpr2 = gpr1 + 1; | //adding “1” forces trailing 1's and the first 0 |
| | //to change their values |
| k2 = kmov(gpr2); | //move back to k-mask register |
| k3 = kxor(k1, k2); | //XOR highlights changed bits − k3 is a mask |
| | //for elements which require update |

vdist{k3} = vpadd(vdist, vdist_add);
vdist_add{k1}{z} = vpadd(vdist, vones); //prepare distance for the next

//vector iteration

vdist_add = vperm(vdist_add, vperm); //broadcast the last distance,

//vperm=(KL−1, KL−1, ..., KL−1)

vstore(&X[i], vdist);
}

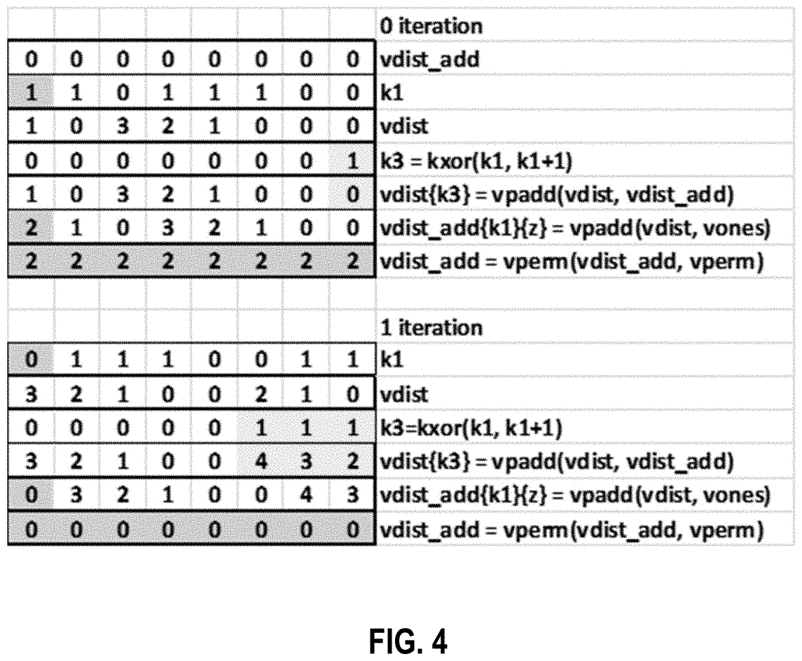

An example for the first two vector iterations from FIG. 1 is shown in FIG. 4. This solution takes the last distance from the previous iteration (vdist_add) and adds it to all distances in vector of distances on current vector iteration (vdist) corresponding to positions in k1 mask at the lower or equal position of the first unset bit, then prepares vdist_add for the next iteration. The shaded elements in vdist row of FIG. 4 indicate elements that “may” need to be updated based on the previous history (however, it is possible that the shaded elements are already correct in some instances and do not require updating).

However, this software solution may have several disadvantages: (1) sequence of 11 instructions required to fully implement functionality of counting distance; (2) only 8-bit and 16-bit masks are supported natively due to restrictions of VPBROADCAS™ instruction (64-bit and 32-bit are not supported, which reduces vector efficiency up to a quarter of possible maximum achieved with 64-bit masks); and (3) three pre-defined vector constants and several temporal are required, which in turn increases register usage/overhead/pressure.

To address these issues, at least one embodiment provides a new vector instruction (referred to herein as “DistRightZero”), which for a given vector mask computes distances from each bit position to the nearest bit position on the right with an unset bit value. To take into account pre-history of distances, last distance from a preceding vector mask is carried over via an additional source operand. The last distance from the preceding vector mask may also or alternatively be stored in a register, etc.

This new instruction resolves problems of the software solution mentioned above, where one instruction replaces 11 instructions in the software emulation sequence, natively supports all types of masks (such as 8-bit, 16-bit, 32-bit, and/or 64-bit), does not require pre-defined constants stored in registers. This instruction can be used by a compiler to auto-vectorize patterns, which can be reduced to distance count functionality (such as conditional RNG calls) with significantly reduced vectorization overhead and the resulting improved vector efficiency (e.g., up to 4×).

In an embodiment, the new instruction can be defined as:

DistRightZero dest, k1, src1, imm8
pos = imm8;
distance = src1[pos]
for(i=0; i<KL; i++){

dest[i] = distance;
if(k1[i]==1)

distance++;

else

distance = 0;

}

Here k1 is an input mask, src1 holds a pre-history value in position defined by imm8, where imm8 refers to a (e.g., byte-sized) portion of the operand in an embodiment; alternatively, the position may be fixed or selected once and used multiple times (so imm8 may be absent from the instruction in some embodiments). This pre-history value is zero if the last bit in previous mask is zero, or holds distance value for the last bit position if the last bit of the previous mask is 1.

In one embodiment, the new instruction follows the EVEX format (such as discussed with reference to FIGS. 7A-7C). Also, in at least one embodiment, k1 may not be used as a writemask but rather as a traditional source, although embodiments are not limited to this and k1 may be stored in a regular vector register and/or a predicate register. Generally, a predicate register may be used for storing data associated with conditional execution, e.g., for conditional/predicated execution and/or selection, or other functions associated with conditional/predictive operations in a processor. Further, while distance count may be performed to the right as discussed herein, it is possible to count the distance to the left depending on the implementation.

Consider two examples of FIG. 5. With the new instruction, vectorized version of the Example 1 loop will look like the following (for KL elements in a vector):

| | |
|---|---|
| vsrc1 = 0; | //initialize input vector with zeroes |

for(i=0, k=0; i<N; ){

k1 = vector_condition(i, i+1, ..., i+KL−1); //evaluate condition
on the

//vector of random numbers

vdist = DistRightZero(k1, vsrc1, KL−1);//compute distances to the

//nearest 0 to right in the mask

vsrc1{k1}{z} = vpadd(vdist, vones); //prepare vsrc1 for the next

//iteration, i.e., handling pre-history

vstore(&X[i], vdist);

}

Using the new vector instruction, the Example 2 loop will be vectorized as follows:

vsrc1 = 0; //initialize input vector with zeroes
for(i=0, k=0; i<N; ){

vrandom = vector_RNG( ); //generate vector of KL random numbers
k1 = vector_condition(vrandom); //evaluate condition on the vector

//of random numbers

vdist = DistRightZero(k1, vsrc1, KL−1);//compute distances to

//the nearest right zero in the mask

vsrc1{k1}{z} = vpadd(vdist, vones); //prepare vsrc1 for the

//next iteration, i.e., handling pre-history

kX = vptestm(vdist, vones); // if the first bit position in each
element

//is 1, then it is X-element; vones = 1:1:1:1:...:1:1

kY = knot(kX); //otherwise it is Y-element
vcompress(kX, vrandom, &x[i]); //compress X-values to array x[ ]

//at current i-position

vcompress(kY, vrandom, &y[k]); //compress Y-values to array y[ ]

//at current k-position

i += popcnt(kX); //shift x pointer by number of compressed X
elements
k += popcnt(kY); //shift y pointer by number of compressed Y
elements

}

Here vsrc1{k1}{z}=vpadd(vdist, vones) is the only overhead to handle pre-history of distances from previous vector iteration. But, this can also be eliminated by handling a carry flag if carry out is required as follows:

DistRightZeroC dest, k1, src1, imm8
pos = imm8;
if(CF==1)

distance = src1[pos];

else

distance = 0;

for(i=0; i<KL; i++){

dest[i] = distance;
if(k1[i]==1)

distance++;

else

distance = 0;

}
if(k1[pos]==1)

CF=1;

else

CF=0

Moreover, to handle pre-history data, if the last bit position in the k1 is 1, it means that the one or more of the first elements of the next iteration would need updating. Since this bit needs to be preserved, the carry flag (CF) may be used in such cases to avoid using another register and/or operation(s). Furthermore, with such a definition, two instructions in this vector loop (vdist=DistRightZero(k1, vsrc1, KL-1) and vsrc1{k1} {z}=vpadd(vdist, vones)) can be replaced with a single instruction (vdist=DistRightZeroC(k1, vdist, KL-1)). Hence, there is no need for pre-defined constants and temporal vectors in this sequence. And, the problem with native support is also resolved. For the corner case of 64-bit mask maximum possible distance is 64 (which would require six bits to store the distance), 64 distances will fit into 8-bit fields of a 512-bit (e.g., ZMM) register in an embodiment.

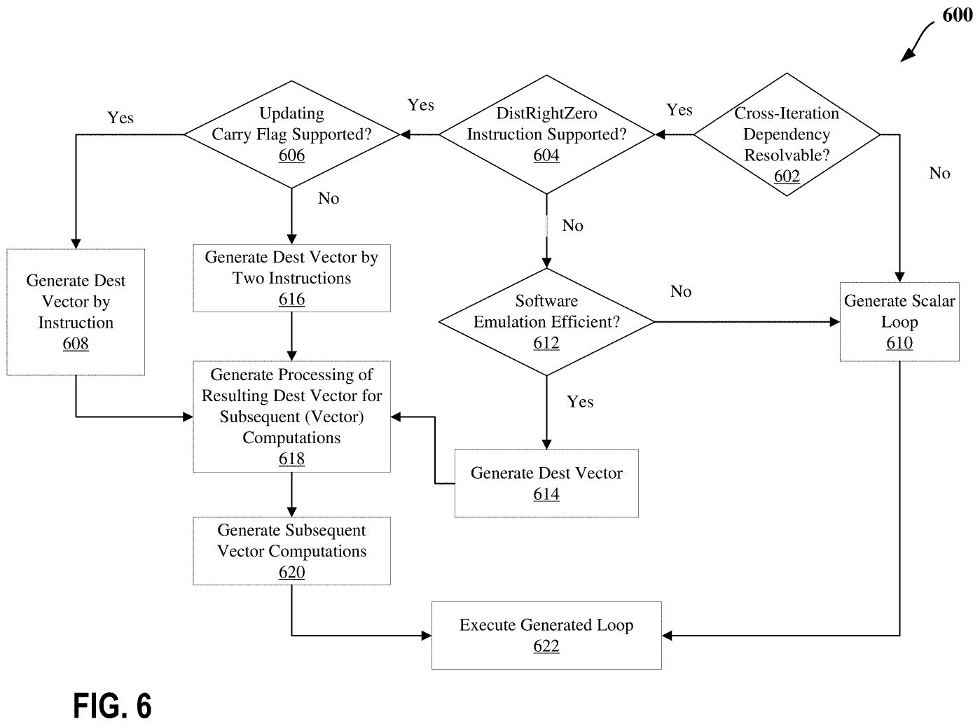

FIG. 6 illustrates a flow chart of a method 600 to vectorize loops with backward cross-iteration dependencies, according to an embodiment. One or more operations of method 600 may be performed by components discussed herein (e.g., with reference to FIG. 7 et seq.) including a processor, a processor core, logic, etc. In at least one embodiment, FIG. 6 illustrates a use case that software can employ to utilize the instruction to vectorize loops discussed herein. In an embodiment, one or more of operations 602 through 620 are performed by software (such as a compiler). Operation 622 may be performed by hardware (e.g., execution unit or other logic circuitry in a processor).

Referring to FIG. 6, vectorization is started at operation 602, which determines whether cross-iteration dependency is resolvable by counting distance to the zero to the right. Operation 602 can be performed based on analysis done by a compiler. For example, if the compiler detects a resolvable pattern (e.g., such as the two examples discussed herein or other patterns identified as resolvable), method 600 continues at operation 604; otherwise, if a resolvable pattern is not recognized, then method 600 continues at operation 610 to generate scalar code.

Operation 604 determines whether the DistRightZero instruction is supported on the target platform. Operation 606 determines whether updating the carry flag of the instruction is supported on the target platform and if so, operation 608 generates the destination (dest) vector by using the vectorization instruction discussed herein. If cross-iteration dependency is not resolvable at operation 602, operation 640 generates a scalar loop. Also, if the instruction is not supported at operation 604, operation 612 determines whether software emulation would be efficient and if not, method 600 resumes at operation 610. If software emulation is efficient, then operation 614 generates the dest vector by software emulation in the vector loop.

At operation 606, if updating the carry flag is not supported, operation 616 generates the dest vector using two instructions (i.e., dest=DistRightZero (k1, src1, imm8) and src1{k1}{z}=vpadd(dest, vones)) in a vector loop. Operation 618 generates processing of the resulting dest vector for the subsequent (vector) computations in the vector loop as discussed herein. Also, method 600 continues with operation 618 after operations 608 and 614. Operation 620 generates the subsequent vector computations in the vector loop. Following operations 610 and 620, method 600 ends at operation 622 by executing the generated (vector or scalar) loop on the target platform.

### Instruction Sets

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

While embodiments will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

FIG. 7A is a block diagram illustrating an exemplary instruction format according to embodiments. FIG. 7A shows an instruction format 700 that is specific in the sense that it specifies the location, size, interpretation, and order of the fields, as well as values for some of those fields. The instruction format 700 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions.

EVEX Prefix (Bytes 0-3) 702—is encoded in a four-byte form.

Format Field 782 (EVEX Byte 0, bits [7:0])—the first byte (EVEX Byte 0) is the format field 782 and it contains 0x62 (the unique value used for distinguishing the vector friendly instruction format in one embodiment).

The second-fourth bytes (EVEX Bytes 1-3) include a number of bit fields providing specific capability.

REX field 705 (EVEX Byte 1, bits [7-5])—consists of a EVEX.R bit field (EVEX Byte 1, bit [7]—R), EVEX.X bit field (EVEX byte 1, bit [6]—X), and 757BEX byte 1, bit[5]—B). The EVEX.R, EVEX.X, and EVEX.B bit fields provide the same functionality as the corresponding VEX bit fields, and are encoded using is complement form, i.e. ZMMO is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field QAc10—this is the EVEX.R′ bit field (EVEX Byte 1, bit [4]—R′) that is used to encode either the upper 16 or lower 16 of the extended 32 register set. In one embodiment, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 715 (EVEX byte 1, bits [3:0]—mmmm)—its content encodes an implied leading opcode byte (OF, OF 38, or OF 3).

Data element width field 764 (EVEX byte 2, bit [7]—W)—is represented by the notation EVEX.W. EVEX.W is used to define the granularity (size) of the datatype (either 32-bit data elements or 64-bit data elements). This field is optional in the sense that it is not needed if only one data element width is supported and/or data element widths are supported using some aspect of the opcodes.

EVEX.vvvv 720 (EVEX Byte 2, bits [6:3]—vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 720 encodes the 4 low-order bits of the first source register specifier stored in inverted (1 s complement) form. Depending on the instruction, an extra different EVEX bit field is used to extend the specifier size to 32 registers.

EVEX.U 768 Class field (EVEX byte 2, bit [2]—U)—If EVEX.0=0, it indicates class A (support merging-writemasking) or EVEX.U0; if EVEX.0=1, it indicates class B (support zeroing and merging-writemasking) or EVEX.U1.

Prefix encoding field 725 (EVEX byte 2, bits [1:0]—pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 753 (EVEX byte 3, bit [7]—EH; also known as EVEX.EH, EVEX.rs, EVEX.RL, EVEX.writemask control, and EVEX.N; also illustrated with a)—its content distinguishes which one of the different augmentation operation types are to be performed.

Beta field 755 (EVEX byte 3, bits [6:4]—SSS, also known as EVEX.s2-0, EVEX.r2-0, EVEX.rr1, EVEX.LL0, EVEX.LLB; also illustrated with f3f3(3)—distinguishes which of the operations of a specified type are to be performed.

REX′ field 710—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Writemask field 771 (EVEX byte 3, bits [2:0]—kkk)—its content specifies the index of a register in the writemask registers. In one embodiment, the specific value EVEX kkk=000 has a special behavior implying no writemask is used for the particular instruction (this may be implemented in a variety of ways including the use of a writemask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the writemask field 771 allows for partial vector operations, including loads, stores, arithmetic, logical, etc. While embodiments are described in which the writemask field's 771 content selects one of a number of writemask registers that contains the writemask to be used (and thus the writemask field's 771 content indirectly identifies that masking to be performed), alternative embodiments instead or additional allow the mask write field's 771 content to directly specify the masking to be performed.

Real Opcode Field 730 (Byte 4) is also known as the opcode byte. Part of the opcode is specified in this field.

MOD R/M Field 740 (Byte 5) includes MOD field 742, register index field 744, and R/M field 746. The MOD field's 742 content distinguishes between memory access and non-memory access operations. The role of register index field 744 can be summarized to two situations: encoding either the destination register operand or a source register operand, or be treated as an opcode extension and not used to encode any instruction operand. The content of register index field 744, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

The role of R/M field 746 may include the following: encoding the instruction operand that references a memory address, or encoding either the destination register operand or a source register operand.

Scale, Index, Base (SIB) Byte (Byte 6)—The scale field's 750 content allows for the scaling of the index field's content for memory address generation (e.g., for address generation that uses 2 scale*index+base). SIB.xxx 754 and SIB.bbb 756—the contents of these fields have been previously referred to with regard to the register indexes Xxxx and Bbbb.

Displacement field 763A (Bytes 7-10)—when MOD field 742 contains 10, bytes 7-10 are the displacement field 763A, and it works the same as the legacy 32-bit displacement (disp32) and works at byte granularity. This may be used as part of memory address generation (e.g., for address generation that uses 2 scale*index+base+displacement).

Displacement factor field 763B (Byte 7)—when MOD field 742 contains 01, byte 7 is the displacement factor field 763B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 763B is a reinterpretation of disp8; when using displacement factor field 763B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 763B substitutes the legacy x86 instruction set 8-bit displacement. Thus, the displacement factor field 763B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate field 772 allows for the specification of an immediate. This field is optional in the sense that is it not present in an implementation of the generic vector friendly format that does not support immediate and it is not present in instructions that do not use an immediate.

### Full Opcode Field

FIG. 7B is a block diagram illustrating the fields of the instruction format 700 that make up the full opcode field 774 according to one embodiment. Specifically, the full opcode field 774 includes the format field 782, the base operation field 743, and the data element width (W) field 763. The base operation field 743 includes the prefix encoding field 725, the opcode map field 715, and the real opcode field 730.

### Register Index Field

FIG. 7C is a block diagram illustrating the fields of the format 700 that make up the register index field 745 according to one embodiment. Specifically, the register index field 745 includes the REX field 705, the REX′ field 710, the MODR/M.reg field 744, the MODR/M.r/m field 746, the VVVV field 720, xxx field 754, and the bbb field 756.

### Augmentation Operation Field

FIG. 7D is a block diagram illustrating the fields of the instruction format 700 that make up an augmentation operation field according to one embodiment. When the class (U) field 768 contains 0, it signifies EVEX.U0 (class A 768A); when it contains 1, it signifies EVEX.U1 (class B 768B). When U=0 and the MOD field 742 contains 11 (signifying a no memory access operation), the alpha field 753 (EVEX byte 3, bit [7]—EH) is interpreted as the rs field 753A. When the rs field 753A contains a 1 (round 753A.1), the beta field 755 (EVEX byte 3, bits [6:4]—SSS) is interpreted as the round control field 755A. The round control field 755A includes a one bit SAE field 796 and a two bit round operation field 798. When the rs field 753A contains a 0 (data transform 753A.2), the beta field 755 (EVEX byte 3, bits [6:4]—SSS) is interpreted as a three bit data transform field 755B. When U=0 and the MOD field 742 contains 00, 01, or 10 (signifying a memory access operation), the alpha field 753 (EVEX byte 3, bit [7]—EH) is interpreted as the eviction hint (EH) field 753B and the beta field 755 (EVEX byte 3, bits [6:4]—SSS) is interpreted as a three bit data manipulation field 755C.

When U=1, the alpha field 753 (EVEX byte 3, bit [7]—EH) is interpreted as the writemask control (Z) field 753C. When U=1 and the MOD field 742 contains 11 (signifying a no memory access operation), part of the beta field 755 (EVEX byte 3, bit [4]—S0) is interpreted as the RL field 757A; when it contains a 1 (round 757A.1) the rest of the beta field 755 (EVEX byte 3, bit [6-5]—S2-1) is interpreted as the round operation field 759A, while when the RL field 757A contains a 0 (VSIZE 757.A2) the rest of the beta field 755 (EVEX byte 3, bit [6-5]—S2-1) is interpreted as the vector length field 759B (EVEX byte 3, bit [6-5]—L1-0). When U=1 and the MOD field 742 contains 00, 01, or 10 (signifying a memory access operation), the beta field 755 (EVEX byte 3, bits [6:4]—SSS) is interpreted as the vector length field 759B (EVEX byte 3, bit [6-5]—L1-0) and the broadcast field 757B (EVEX byte 3, bit [4]—B).

### Exemplary Register Architecture

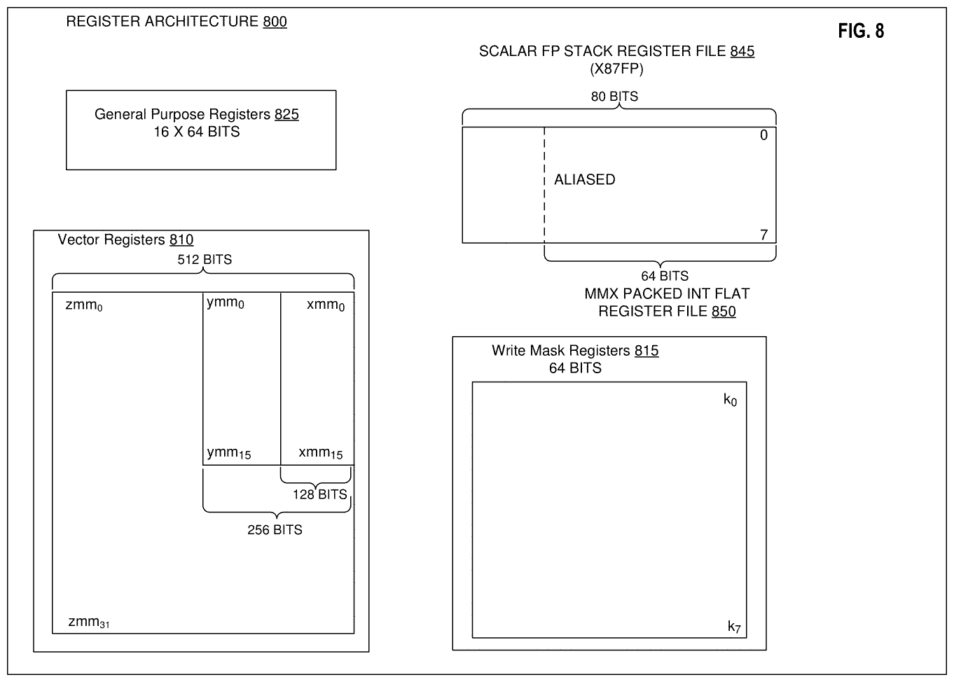

FIG. 8 is a block diagram of a register architecture 800 according to one embodiment. In the embodiment illustrated, there are 32 vector registers 810 that are 512 bits wide; these registers are referenced as ZMMO through ZMM31. The lower order 256 bits of the lower 16 ZMM registers are overlaid on registers YMM0-16. The lower order 128 bits of the lower 16 ZMM registers (the lower order 128 bits of the YMM registers) are overlaid on registers XMM0-15. In other words, the vector length field 759B selects between a maximum length and one or more other shorter lengths, where each such shorter length is half the length of the preceding length; and instructions templates without the vector length field 759B operate on the maximum vector length. Further, in one embodiment, the class B instruction templates of the instruction format 700 operate on packed or scalar single/double-precision floating point data and packed or scalar integer data. Scalar operations are operations performed on the lowest order data element position in a ZMM/YMM/XMM register; the higher order data element positions are either left the same as they were prior to the instruction or zeroed depending on the embodiment.

Writemask registers 815—in the embodiment illustrated, there are 8 writemask registers (k0 through k7), each 64 bits in size. In an alternate embodiment, the writemask registers 815 are 16 bits in size. In some embodiments, the vector mask register k0 cannot be used as a writemask; when the encoding that would normally indicate k0 is used for a writemask, it selects a hardwired writemask of 0xFFFF, effectively disabling writemasking for that instruction.

General-purpose registers 825—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 845, on which is aliased the MMX packed integer flat register file 850—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments may use wider or narrower registers. Additionally, alternative embodiments may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

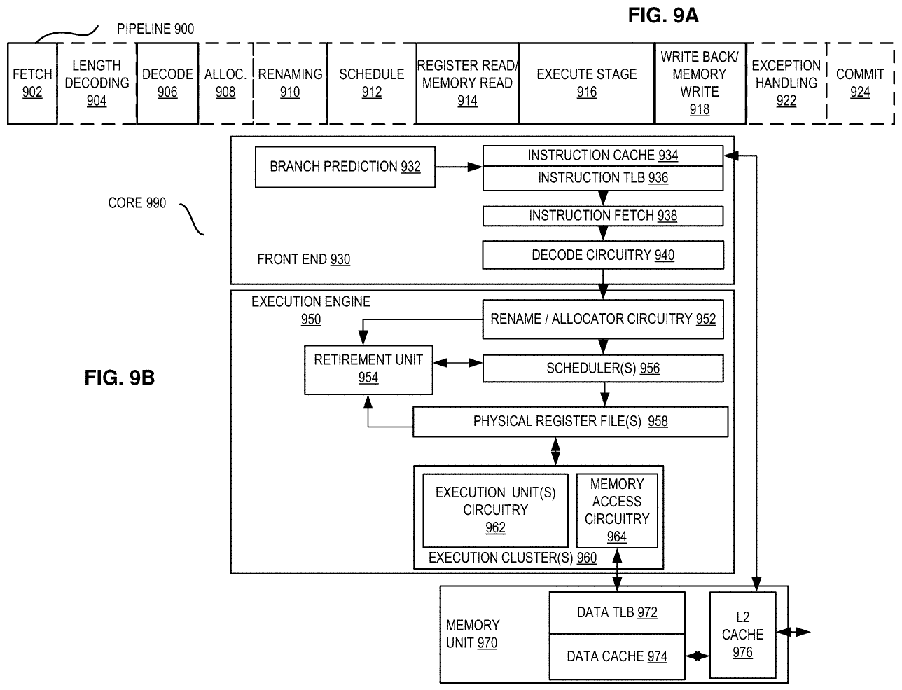

FIG. 9A is a block diagram illustrating both an exemplary in-order pipeline and an exemplary register renaming, out-of-order issue/execution pipeline according to embodiments. FIG. 9B is a block diagram illustrating both an exemplary embodiment of an in-order architecture core and an exemplary register renaming, out-of-order issue/execution architecture core to be included in a processor according to embodiments. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 9B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point—status (e.g., an instruction pointer that is the address of the next instruction to be executed), etc. In one embodiment, the physical register file(s) unit 958 comprises a vector registers unit, a writemask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

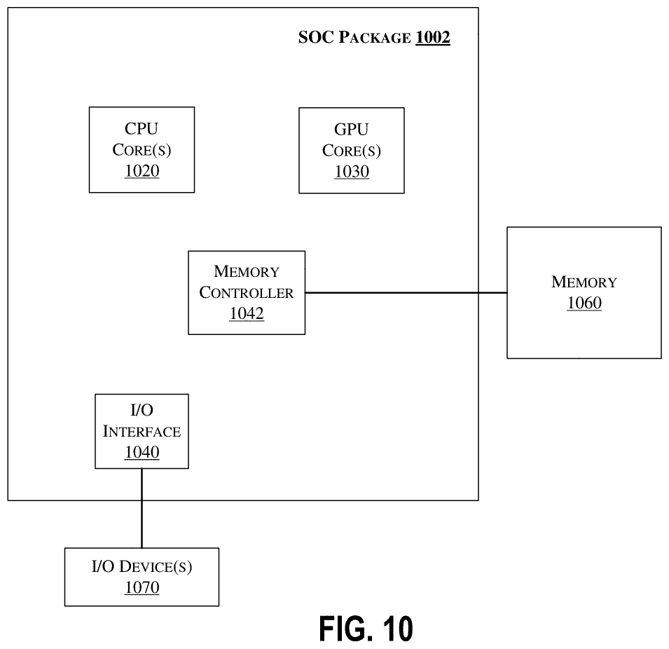

FIG. 10 illustrates a block diagram of an SOC package in accordance with an embodiment. As illustrated in FIG. 10, SOC 1002 includes one or more Central Processing Unit (CPU) cores 1020, one or more Graphics Processor Unit (GPU) cores 1030, an Input/Output (I/O) interface 1040, and a memory controller 1042. Various components of the SOC package 1002 may be coupled to an interconnect or bus such as discussed herein with reference to the other figures. Also, the SOC package 1002 may include more or less components, such as those discussed herein with reference to the other figures. Further, each component of the SOC package 1002 may include one or more other components, e.g., as discussed with reference to the other figures herein. In one embodiment, SOC package 1002 (and its components) is provided on one or more Integrated Circuit (IC) die, e.g., which are packaged into a single semiconductor device.

As illustrated in FIG. 10, SOC package 1002 is coupled to a memory 1060 via the memory controller 1042. In an embodiment, the memory 1060 (or a portion of it) can be integrated on the SOC package 1002.

The I/O interface 1040 may be coupled to one or more I/O devices 1070, e.g., via an interconnect and/or bus such as discussed herein with reference to other figures. I/O device(s) 1070 may include one or more of a keyboard, a mouse, a touchpad, a display, an image/video capture device (such as a camera or camcorder/video recorder), a touch screen, a speaker, or the like.

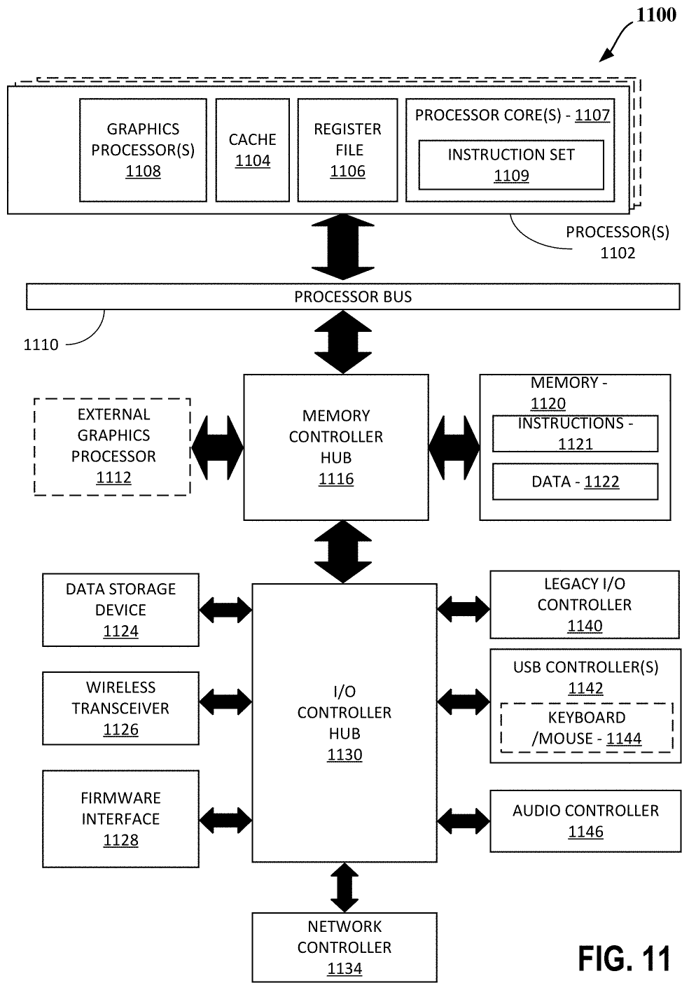

FIG. 11 is a block diagram of a processing system 1100, according to an embodiment. In various embodiments the system 1100 includes one or more processors 1102 and one or more graphics processors 1108, and may be a single processor desktop system, a multiprocessor workstation system, or a server system having a large number of processors 1102 or processor cores 1107. In on embodiment, the system 1100 is a processing platform incorporated within a system-on-a-chip (SoC or SOC) integrated circuit for use in mobile, handheld, or embedded devices.

An embodiment of system 1100 can include, or be incorporated within a server-based gaming platform, a game console, including a game and media console, a mobile gaming console, a handheld game console, or an online game console. In some embodiments system 1100 is a mobile phone, smart phone, tablet computing device or mobile Internet device. Data processing system 1100 can also include, couple with, or be integrated within a wearable device, such as a smart watch wearable device, smart eyewear device, augmented reality device, or virtual reality device. In some embodiments, data processing system 1100 is a television or set top box device having one or more processors 1102 and a graphical interface generated by one or more graphics processors 1108.

In some embodiments, the one or more processors 1102 each include one or more processor cores 1107 to process instructions which, when executed, perform operations for system and user software. In some embodiments, each of the one or more processor cores 1107 is configured to process a specific instruction set 1109. In some embodiments, instruction set 1109 may facilitate Complex Instruction Set Computing (CISC), Reduced Instruction Set Computing (RISC), or computing via a Very Long Instruction Word (VLIW). Multiple processor cores 1107 may each process a different instruction set 1109, which may include instructions to facilitate the emulation of other instruction sets. Processor core 1107 may also include other processing devices, such a Digital Signal Processor (DSP).

In some embodiments, the processor 1102 includes cache memory 1104. Depending on the architecture, the processor 1102 can have a single internal cache or multiple levels of internal cache. In some embodiments, the cache memory is shared among various components of the processor 1102. In some embodiments, the processor 1102 also uses an external cache (e.g., a Level-3 (L3) cache or Last Level Cache (LLC)) (not shown), which may be shared among processor cores 1107 using known cache coherency techniques. A register file 1106 is additionally included in processor 1102 which may include different types of registers for storing different types of data (e.g., integer registers, floating point registers, status registers, and an instruction pointer register). Some registers may be general-purpose registers, while other registers may be specific to the design of the processor 1102.

In some embodiments, processor 1102 is coupled to a processor bus 1110 to transmit communication signals such as address, data, or control signals between processor 1102 and other components in system 1100. In one embodiment the system 1100 uses an exemplary ‘hub’ system architecture, including a memory controller hub 1116 and an Input Output (I/O) controller hub 1130. A memory controller hub 1116 facilitates communication between a memory device and other components of system 1100, while an I/O Controller Hub (ICH) 1130 provides connections to I/O devices via a local I/O bus. In one embodiment, the logic of the memory controller hub 1116 is integrated within the processor.

Memory device 1120 can be a dynamic random access memory (DRAM) device, a static random access memory (SRAM) device, flash memory device, phase-change memory device, or some other memory device having suitable performance to serve as process memory. In one embodiment the memory device 1120 can operate as system memory for the system 1100, to store data 1122 and instructions 1121 for use when the one or more processors 1102 executes an application or process. Memory controller hub 1116 also couples with an optional external graphics processor 1112, which may communicate with the one or more graphics processors 1108 in processors 1102 to perform graphics and media operations.

In some embodiments, ICH 1130 enables peripherals to connect to memory device 1120 and processor 1102 via a high-speed I/O bus. The I/O peripherals include, but are not limited to, an audio controller 1146, a firmware interface 1128, a wireless transceiver 1126 (e.g., Wi-Fi, Bluetooth), a data storage device 1124 (e.g., hard disk drive, flash memory, etc.), and a legacy I/O controller 1140 for coupling legacy (e.g., Personal System 2 (PS/2)) devices to the system. One or more Universal Serial Bus (USB) controllers 1142 connect input devices, such as keyboard and mouse 1144 combinations. A network controller 1134 may also couple to ICH 1130. In some embodiments, a high-performance network controller (not shown) couples to processor bus 1110. It will be appreciated that the system 1100 shown is exemplary and not limiting, as other types of data processing systems that are differently configured may also be used. For example, the I/O controller hub 1130 may be integrated within the one or more processor 1102, or the memory controller hub 1116 and I/O controller hub 1130 may be integrated into a discreet external graphics processor, such as the external graphics processor 1112.

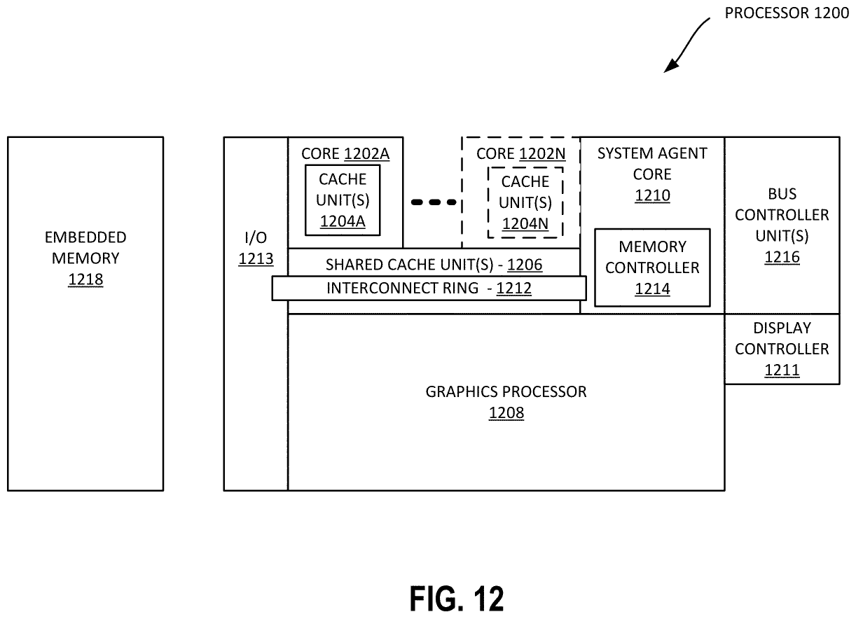

FIG. 12 is a block diagram of an embodiment of a processor 1200 having one or more processor cores 1202A to 1202N, an integrated memory controller 1214, and an integrated graphics processor 1208. Those elements of FIG. 12 having the same reference numbers (or names) as the elements of any other figure herein can operate or function in any manner similar to that described elsewhere herein, but are not limited to such. Processor 1200 can include additional cores up to and including additional core 1202N represented by the dashed lined boxes. Each of processor cores 1202A to 1202N includes one or more internal cache units 1204A to 1204N. In some embodiments each processor core also has access to one or more shared cached units 1206.

The internal cache units 1204A to 1204N and shared cache units 1206 represent a cache memory hierarchy within the processor 1200. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 1206 and 1204A to 1204N.

In some embodiments, processor 1200 may also include a set of one or more bus controller units 1216 and a system agent core 1210. The one or more bus controller units 1216 manage a set of peripheral buses, such as one or more Peripheral Component Interconnect buses (e.g., PCI, PCI Express). System agent core 1210 provides management functionality for the various processor components. In some embodiments, system agent core 1210 includes one or more integrated memory controllers 1214 to manage access to various external memory devices (not shown).

In some embodiments, one or more of the processor cores 1202A to 1202N include support for simultaneous multi-threading. In such embodiment, the system agent core 1210 includes components for coordinating and operating cores 1202A to 1202N during multi-threaded processing. System agent core 1210 may additionally include a power control unit (PCU), which includes logic and components to regulate the power state of processor cores 1202A to 1202N and graphics processor 1208.

In some embodiments, processor 1200 additionally includes graphics processor 1208 to execute graphics processing operations. In some embodiments, the graphics processor 1208 couples with the set of shared cache units 1206, and the system agent core 1210, including the one or more integrated memory controllers 1214. In some embodiments, a display controller 1211 is coupled with the graphics processor 1208 to drive graphics processor output to one or more coupled displays. In some embodiments, display controller 1211 may be a separate module coupled with the graphics processor via at least one interconnect, or may be integrated within the graphics processor 1208 or system agent core 1210.

In some embodiments, a ring based interconnect unit 1212 is used to couple the internal components of the processor 1200. However, an alternative interconnect unit may be used, such as a point-to-point interconnect, a switched interconnect, or other techniques, including techniques well known in the art. In some embodiments, graphics processor 1208 couples with the ring interconnect 1212 via an I/O link 1213.

The exemplary I/O link 1213 represents at least one of multiple varieties of I/O interconnects, including an on package I/O interconnect which facilitates communication between various processor components and a high-performance embedded memory module 1218, such as an eDRAM (or embedded DRAM) module. In some embodiments, each of the processor cores 1202 to 1202N and graphics processor 1208 use embedded memory modules 1218 as a shared Last Level Cache.

In some embodiments, processor cores 1202A to 1202N are homogenous cores executing the same instruction set architecture. In another embodiment, processor cores 1202A to 1202N are heterogeneous in terms of instruction set architecture (ISA), where one or more of processor cores 1202A to 1202N execute a first instruction set, while at least one of the other cores executes a subset of the first instruction set or a different instruction set. In one embodiment processor cores 1202A to 1202N are heterogeneous in terms of microarchitecture, where one or more cores having a relatively higher power consumption couple with one or more power cores having a lower power consumption. Additionally, processor 1200 can be implemented on one or more chips or as an SoC integrated circuit having the illustrated components, in addition to other components.

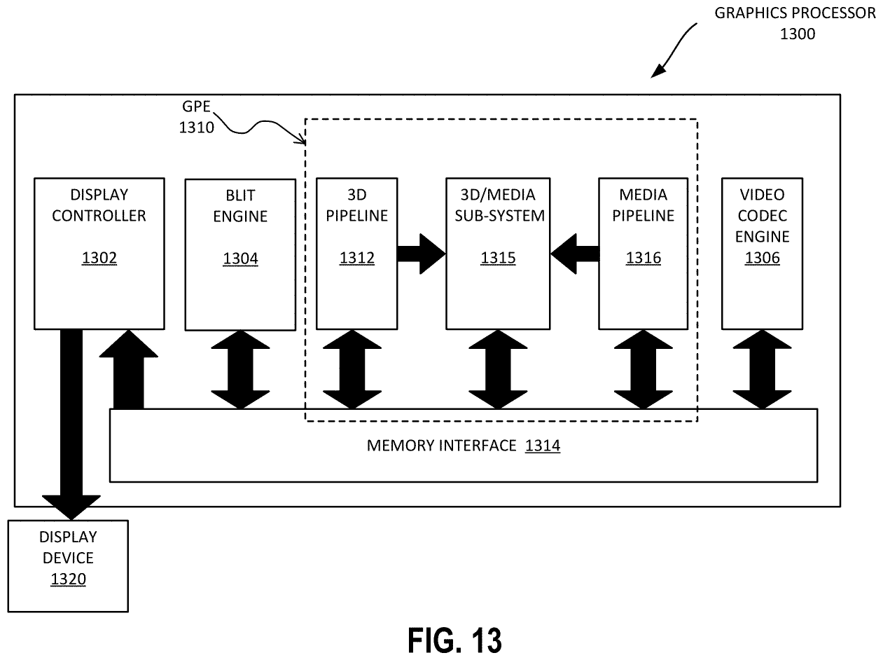

FIG. 13 is a block diagram of a graphics processor 1300, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1300 includes a memory interface 1314 to access memory. Memory interface 1314 can be an interface to local memory, one or more internal caches, one or more shared external caches, and/or to system memory.

In some embodiments, graphics processor 1300 also includes a display controller 1302 to drive display output data to a display device 1320. Display controller 1302 includes hardware for one or more overlay planes for the display and composition of multiple layers of video or user interface elements. In some embodiments, graphics processor 1300 includes a video codec engine 1306 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 1300 includes a block image transfer (BLIT) engine 1304 to perform two-dimensional (2D) rasterizer operations including, for example, bit-boundary block transfers. However, in one embodiment, 13D graphics operations are performed using one or more components of graphics processing engine (GPE) 1310. In some embodiments, graphics processing engine 1310 is a compute engine for performing graphics operations, including three-dimensional (3D) graphics operations and media operations.

In some embodiments, GPE 1310 includes a 3D pipeline 1312 for performing 3D operations, such as rendering three-dimensional images and scenes using processing functions that act upon 3D primitive shapes (e.g., rectangle, triangle, etc.). The 3D pipeline 1312 includes programmable and fixed function elements that perform various tasks within the element and/or spawn execution threads to a 3D/Media sub-system 1315. While 3D pipeline 1312 can be used to perform media operations, an embodiment of GPE 1310 also includes a media pipeline 1316 that is specifically used to perform media operations, such as video post-processing and image enhancement.

In some embodiments, media pipeline 1316 includes fixed function or programmable logic units to perform one or more specialized media operations, such as video decode acceleration, video de-interlacing, and video encode acceleration in place of, or on behalf of video codec engine 1306. In some embodiments, media pipeline 1316 additionally includes a thread spawning unit to spawn threads for execution on 3D/Media sub-system 1315. The spawned threads perform computations for the media operations on one or more graphics execution units included in 3D/Media sub-system 1315.

In some embodiments, 3D/Media subsystem 1315 includes logic for executing threads spawned by 3D pipeline 1312 and media pipeline 1316. In one embodiment, the pipelines send thread execution requests to 3D/Media subsystem 1315, which includes thread dispatch logic for arbitrating and dispatching the various requests to available thread execution resources. The execution resources include an array of graphics execution units to process the 3D and media threads. In some embodiments, 3D/Media subsystem 1315 includes one or more internal caches for thread instructions and data. In some embodiments, the subsystem also includes shared memory, including registers and addressable memory, to share data between threads and to store output data.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: decode circuitry to decode an instruction, the instruction including an identifier of previous distance data for a preceding vector mask; and execution circuitry to execute the instruction to resolve a cross-iteration dependency of one or more operations of a loop, wherein the instruction is to resolve the cross-iteration dependency of the one or more operations based at least in part on one or more distance count computations to a preceding iteration of the loop. Example 2 includes the apparatus of example 1, wherein a writemask register is to store the previous distance data. Example 3 includes the apparatus of example 1, wherein a vector register is to store the previous distance data. Example 4 includes the apparatus of example 1, wherein a predicate register is to store the previous distance data. Example 5 includes the apparatus of example 1, wherein an operand of the instruction includes the identifier of the previous distance data. Example 6 includes the apparatus of example 1, wherein a register is to store the identifier of the previous distance data. Example 7 includes the apparatus of example 1, wherein the preceding loop iteration corresponds to a location where the cross-iteration dependency terminates. Example 8 includes the apparatus of example 1, wherein the instruction is to resolve a plurality of cross-iteration dependencies of the one or more operations of the loop. Example 9 includes the apparatus of example 1, comprising logic to determine the one or more distance count computations to the preceding loop iteration based at least in part on distance computations for each bit position of an input mask to a nearest bit position with an unset bit value. Example 10 includes the apparatus of example 1, wherein a portion of an operand of the instruction comprises the previous distance data for the preceding vector mask. Example 11 includes the apparatus of example 1, wherein a processor, having one or more processor cores, comprises one or more of the decode circuitry, the execution circuitry, and memory to store the instruction. Example 12 includes the apparatus of example 11, wherein the processor and the memory are on a single integrated circuit die. Example 13 includes the apparatus of example 11, wherein the processor comprises a Graphics Processing Unit (GPU), having one or more graphics processing cores. Example 14 includes the apparatus of example 1, wherein the decode circuitry is to decode the instruction to generate a plurality of micro-operations, micro-code entry points, or microinstructions.

Example 15 includes one or more non-transitory computer-readable media comprising one or more instructions that when executed on at least one processor configure the at least one processor to perform one or more operations to: decode an instruction, the instruction including an identifier of previous distance data for a preceding vector mask; and execute the instruction to resolve a cross-iteration dependency of one or more operations of a loop, wherein the instruction resolves the cross-iteration dependency of the one or more operations based at least in part on one or more distance count computations to a preceding iteration of the loop. Example 16 includes the one or more non-transitory computer-readable media of example 14, further comprising one or more instructions that when executed on the at least one processor configure the at least one processor to perform one or more operations to cause storage of the identifier of the previous distance data in one or more of a writemask register, a vector register, and a predicate register. Example 17 includes the one or more non-transitory computer-readable media of example 14, further comprising one or more instructions that when executed on the at least one processor configure the at least one processor to perform one or more operations to cause determination of the one or more distance count computations to the preceding loop iteration based at least in part on distance computations for each bit position of an input mask to a nearest bit position with an unset bit value. Example 18 includes the one or more non-transitory computer-readable media of example 14, further comprising one or more instructions that when executed on the at least one processor configure the at least one processor to perform one or more operations to cause storage of the identifier of the previous distance data in a register. Example 19 includes the one or more non-transitory computer-readable media of example 14, wherein the preceding loop iteration corresponds to a location where the cross-iteration dependency terminates. Example 20 includes the one or more non-transitory computer-readable media of example 14, wherein a portion of an operand of the instruction comprises the previous distance data for the preceding vector mask.

Example 21 includes a method comprising: decoding an instruction, the instruction including an identifier of previous distance data for a preceding vector mask; and executing the instruction to resolve a cross-iteration dependency of one or more operations of a loop, wherein the instruction resolves the cross-iteration dependency of the one or more operations based at least in part on one or more distance count computations to a preceding iteration of the loop. Example 22 includes the method of example 21, further comprising storing the identifier of the previous distance data in one or more of a writemask register, a vector register, and a predicate register. Example 23 includes the method of example 21, further comprising determining the one or more distance count computations to the preceding loop iteration based at least in part on distance computations for each bit position of an input mask to a nearest bit position with an unset bit value.

Example 24 includes an apparatus comprising means to perform a method as set forth in any preceding example. Example 25 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In various embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
decode circuitry to decode an instruction, the instruction including an identifier of previous distance data for a preceding vector mask; and
execution circuitry to execute the instruction to resolve a cross-iteration dependency of one or more operations of a loop,
wherein the instruction is to resolve the cross-iteration dependency of the one or more operations based at least in part on one or more distance count computations to a preceding iteration of the loop.

2. The apparatus of claim 1, wherein a writemask register is to store the previous distance data.

3. The apparatus of claim 1, wherein a vector register is to store the previous distance data.

4. The apparatus of claim 1, wherein a predicate register is to store the previous distance data.

5. The apparatus of claim 1, wherein an operand of the instruction includes the identifier of the previous distance data.

6. The apparatus of claim 1, wherein a register is to store the identifier of the previous distance data.

7. The apparatus of claim 1, wherein the preceding loop iteration corresponds to a location where the cross-iteration dependency terminates.

8. The apparatus of claim 1, wherein the instruction is to resolve a plurality of cross-iteration dependencies of the one or more operations of the loop.

9. The apparatus of claim 1, comprising logic to determine the one or more distance count computations to the preceding loop iteration based at least in part on distance computations for each bit position of an input mask to a nearest bit position with an unset bit value.

10. The apparatus of claim 1, wherein a portion of an operand of the instruction comprises the previous distance data for the preceding vector mask.

11. The apparatus of claim 1, wherein a processor, having one or more processor cores, comprises one or more of the decode circuitry, the execution circuitry, and memory to store the instruction.

12. The apparatus of claim 11, wherein the processor and the memory are on a single integrated circuit die.

13. The apparatus of claim 11, wherein the processor comprises a Graphics Processing Unit (GPU), having one or more graphics processing cores.

14. The apparatus of claim 1, wherein the decode circuitry is to decode the instruction to generate a plurality of micro-operations, micro-code entry points, or microinstructions.

15. One or more non-transitory computer-readable media comprising one or more instructions that when executed on at least one processor configure the at least one processor to perform one or more operations to:
decode an instruction, the instruction including an identifier of previous distance data for a preceding vector mask; and
execute the instruction to resolve a cross-iteration dependency of one or more operations of a loop,
wherein the instruction resolves the cross-iteration dependency of the one or more operations based at least in part on one or more distance count computations to a preceding iteration of the loop.

16. The one or more non-transitory computer-readable media of claim 14, further comprising one or more instructions that when executed on the at least one processor configure the at least one processor to perform one or more operations to cause storage of the identifier of the previous distance data in one or more of a writemask register, a vector register, and a predicate register.

17. The one or more non-transitory computer-readable media of claim 14, further comprising one or more instructions that when executed on the at least one processor configure the at least one processor to perform one or more operations to cause determination of the one or more distance count computations to the preceding loop iteration based at least in part on distance computations for each bit position of an input mask to a nearest bit position with an unset bit value.

18. The one or more non-transitory computer-readable media of claim 14, further comprising one or more instructions that when executed on the at least one processor configure the at least one processor to perform one or more operations to cause storage of the identifier of the previous distance data in a register.

19. The one or more non-transitory computer-readable media of claim 14, wherein the preceding loop iteration corresponds to a location where the cross-iteration dependency terminates.

20. The one or more non-transitory computer-readable media of claim 14, wherein a portion of an operand of the instruction comprises the previous distance data for the preceding vector mask.
